(19) United States
(12) Patent Application Publication
(10) Pub. No.: US 2016/0094357 A1
(43) Pub. Date: Mar. 31, 2016

(54) CONTROL APPARATUS, COMPUTER SYSTEM, COMMUNICATION CONTROL METHOD, AND PROGRAM

(71) Applicant: NEC Corporation, Minato-ku, Tokyo (JP)

(72) Inventors: Junichi Yamato, Tokyo (JP); Yoshihiro Hasebe, Tokyo (JP)

(21) Appl. No.: 14/786,203

(22) PCT Filed: Apr. 23, 2014
(86) PCT No.: PCT/JP2014/061438

§ 371 Date: Oct. 22, 2015

(30) Foreign Application Priority Data
Apr. 24, 2013 (JP) 2013-091469

(51) Int. Cl. H04L 12/18; H04L 12/26; H04L 12/24; H04L 12/761; H04L 12/741

(52) U.S. Cl. CPC H04L 12/1886; H04L 45/16; H04L 45/745; H04L 41/0813; H04L 43/10; H04L 12/185

(57) ABSTRACT

A control apparatus includes: a communication identification unit that identifies a predetermined communication between or among predetermined apparatuses by matching a packet received via a switch against a preset pattern(s); and a switch control unit that sets, at least in the switch, control information in which match conditions for determining the predetermined communication between or among the predetermined apparatuses and a processing content(s) applied to the communication between or among the apparatuses are associated with each other.

### REFERENCE TO RELATED APPLICATION

The present invention is based upon and claims the benefit of the priority of Japanese patent application No. 2013-091469, filed on Apr. 24, 2013, the disclosure of which is incorporated herein in its entirety by reference thereto.

### FIELD

The present invention relates to a control apparatus, a computer system, a communication control method, and a program. In particular, the present invention relates to: a control apparatus that controls switches that processes received packets on the basis of externally set control information; a computer system, a communication control method, and a program.

### BACKGROUND

There are known computer systems in which a certain apparatus transmits heartbeat notifications or alive-monitoring packets to other apparatuses and monitoring apparatuses. These heartbeat notifications and alive-monitoring packets are exchanged by broadcasting or multicasting. For example, in an environment in which IPMIs (intelligent platform management interfaces) are used, there are cases in which a control unit called a BMC (baseboard management controller) broadcasts gratuitous ARP (address resolution protocol) packets by using a watchdog timer. A software product called Heartbeat of Linux (registered mark) HA (High-Availability Linux) also performs alive monitoring by broadcasting.

Non-Patent Literatures 1 and 2 disclose a technique called OpenFlow, which will be mentioned in exemplary embodiments of the present invention.

Patent Literatures 1 to 3 are examples of OpenFlow-related inventions by the applicant of the present application.

### CITATION LIST

### Patent Literature

Patent Literature 1: Japanese Patent Kokai Publication No. JP2011-160363A
Patent Literature 2: Japanese Patent Kokai Publication No. JP 2011-081588A
Patent Literature 3: Japanese Patent Kokai Publication No. JP 2012-165335A

### Non-Patent Literature

Non-Patent Literature 1: Nick McKeown, and seven others, “OpenFlow: Enabling Innovation in Campus Networks,” [online], [searched on Apr. 10, 2013], Internet <URL:http://www.openflow.org/documents/openflow-wp-latest.pdf>
Non-Patent Literature 2: “OpenFlow Switch Specification” Version 1.3.1 (Wire Protocol 0x04), [online], [searched on Apr. 10, 2013], Internet <URL: https://www.opennetworking.org/images/stories/downloads/sdn-resourc es/onf-specifications/openflow/openflow-spec-v1.3.1.pdf>

### SUMMARY

### Technical Problem

The following analysis has been given by the present inventors. In the above computer systems, since an apparatus transmits heartbeat notifications or alive-monitoring packets by broadcasting or multicasting, destinations of these packets do not need to be specified or managed. In addition, the packets can be forwarded to a plurality of apparatuses.

However, if such apparatus that transmits heartbeat notifications or alive-monitoring packets by broadcasting or multicasting is connected, there is a problem that these packets are forwarded throughout the entire network. Generally, these packets are not needed by apparatuses other than those targeted by the transmission-source apparatus. In addition, depending on the number of apparatuses that transmit these packets, the network and other apparatuses can be subjected to a non-negligible amount of load.

As described above, exchange of heartbeat notifications or alive-monitoring packets between or among predetermined apparatuses affects the network and other irrelevant apparatuses. It is an object of the present invention to provide a control apparatus, a computer system, a communication control method, and a program that can reduce the impact caused by the exchange.

### Solution to Problem

According to a first aspect, there is provided a control apparatus, including: a communication identification unit that identifies a predetermined communication between or among predetermined apparatuses by matching a packet received via a switch against a preset pattern(s); and a switch control unit that sets, at least in the switch, control information in which match conditions for determining the communication between or among the apparatuses and a processing content(s) applied to the predetermined communication between or among the predetermined apparatuses are associated with each other.

According to a second aspect, there is provided a computer system, including: a plurality of apparatuses that perform a predetermined communication in accordance with a predetermined procedure; a switch(es) that processes received packets by referring to control information set by a control apparatus; and the control apparatus that includes: a communication identification unit that identifies the predetermined communication between or among the plurality of apparatuses by matching a packet received via one of the switch(es) against a preset pattern(s); and a switch control unit that sets, at least in the switch, control information in which match conditions for determining the predetermined communication between or among the predetermined apparatuses and a processing content(s) applied to the communication between or among the apparatuses are associated with each other.

According to a third aspect, there is provided a communication control method, including steps of: causing a control apparatus, which controls a switch(es) that processes received packets by referring to control information set by the control apparatus, to identify a predetermined communication between or among predetermined apparatuses by matching a packet received via one of the switch(es) against a preset pattern(s); and causing the control apparatus to set, at least in the switch, control information in which match conditions for determining the communication between the apparatuses and a processing content(s) applied to the predetermined communication between the predetermined apparatuses are associated with each other. This method is associated with a certain machine, namely, with the control apparatus that controls the above switch(es).

According to a fourth aspect, there is provided a program, causing a computer, which controls a switch(es) that processes received packets by referring to control information set by a control apparatus, to perform processing for: identifying a predetermined communication between or among predetermined apparatuses by matching a packet received via one of the switch(es) against a preset pattern(s); and setting, at least in the switch, control information in which match conditions for determining the communication between or among the apparatuses and a processing content(s) applied to the predetermined communication between the predetermined apparatuses are associated with each other. The program may be recorded in a computer-readable (non-transitory) storage medium. Namely, the present invention can be embodied as a computer program product.

### Advantageous Effects of Invention

According to the present invention, the impact on a network and an irrelevant apparatus(es) caused by exchange of heartbeat notifications or alive-monitoring packets between or among predetermined apparatuses can be reduced.

### BRIEF DESCRIPTION OF DRAWINGS

FIG. 1 illustrates a configuration according to an exemplary embodiment of the present invention.

FIG. 2 illustrates a configuration of a computer system according to a first exemplary embodiment of the present invention.

FIG. 3 illustrates an exemplary entry held in an inter-server notification configuration database (inter-server notification configuration DB) according to the first exemplary embodiment of the present invention.

FIG. 4 illustrates a configuration of an OpenFlow switch (OFS) according to the first exemplary embodiment of the present invention.

FIG. 5 illustrates an exemplary entry held in a flow table of the OpenFlow switch (OFS) according to the first exemplary embodiment of the present invention.

FIG. 6 illustrates exemplary processing contents that can be set in the instruction field of the entry in FIG. 5.

FIG. 7 illustrates a configuration of an OpenFlow controller (OFC) according to the first exemplary embodiment of the present invention.

FIG. 8 illustrates exemplary entries held in a topology database (topology DB) in the OpenFlow controller (OFC) according to the first exemplary embodiment of the present invention.

FIG. 9 illustrates an exemplary entry held in a notification forwarding table of the OpenFlow controller (OFC) according to the first exemplary embodiment of the present invention.

FIG. 10 illustrates an exemplary entry held in a group management table of the OpenFlow controller (OFC) according to the first exemplary embodiment of the present invention.

FIG. 11 illustrates a configuration of a control-target-communication notification apparatus according to the first exemplary embodiment of the present invention.

FIG. 12 illustrates an exemplary entry held in a pattern database (pattern DB) in the control-target-communication notification apparatus according to the first exemplary embodiment of the present invention.

FIG. 13 illustrates a network configuration with which an operation according to the first exemplary embodiment of the present invention will be described.

FIG. 14 is a flowchart illustrating a basic operation of the OFS according to the first exemplary embodiment of the present invention.

FIG. 15 is a flowchart illustrating an operation of the OFC according to the first exemplary embodiment of the present invention.

FIG. 16 is a sequence diagram illustrating an operation of the computer system according to the first exemplary embodiment of the present invention (upon occurrence of a unicast communication).

FIG. 17 is a sequence diagram illustrating an operation of the computer system according to the first exemplary embodiment of the present invention (upon occurrence of a broadcast communication of which the OFC has not been notified yet).

FIG. 18 is a sequence diagram illustrating an operation of the computer system according to the first exemplary embodiment of the present invention (upon occurrence of a broadcast communication of which the OFC has already been notified).

FIG. 19 is a sequence diagram illustrating an operation of the computer system according to the first exemplary embodiment of the present invention (upon occurrence of a broadcast communication of which the OFC has already been notified).

FIG. 20 illustrates a configuration of a computer system according to a second exemplary embodiment of the present invention.

FIG. 21 illustrates a configuration of an OpenFlow controller (OFC) according to the second exemplary embodiment of the present invention.

FIG. 22 illustrates a network configuration with which an operation according to the second exemplary embodiment of the present invention will be described.

FIG. 23 is a flowchart illustrating an operation of the OFC according to the second exemplary embodiment of the present invention.

FIG. 24 is a sequence diagram illustrating an operation of the computer system according to the second exemplary embodiment of the present invention (upon addition of an entry).

FIG. 25 is a sequence diagram illustrating an operation of the computer system according to the second exemplary embodiment of the present invention (upon change of an entry).

FIG. 26 is a sequence diagram illustrating an operation of the computer system according to the second exemplary embodiment of the present invention (upon deletion of an entry).

### DESCRIPTION OF EMBODIMENTS

First, an outline of an exemplary embodiment of the present invention will be described with reference to the drawing. In the following outline, various elements are denoted by reference characters for the sake of convenience. Namely, the following reference characters are merely used as examples to facilitate understanding of the present invention, not to limit the present invention to the illustrated modes.

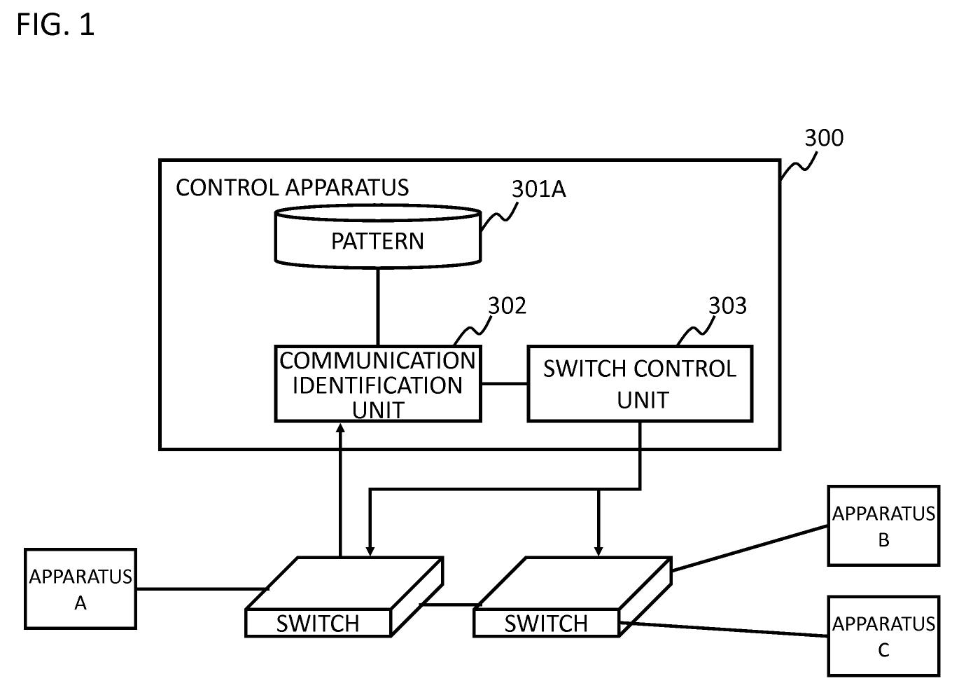

As illustrated in FIG. 1, an exemplary embodiment of the present invention can be realized by a control apparatus 300 that includes a communication identification unit 302 and a switch control unit 303. More specifically, the communication identification unit 302 identifies a predetermined communication between or among predetermined apparatuses by matching a packet received via a switch against a preset pattern(s) 301A.

Next, the switch control unit 303 sets, at least in the switch, control information in which match conditions for determining the predetermined communication between or among the predetermined apparatuses and a processing content(s) applied to the communication between or among the apparatuses are associated with each other.

According to the above configuration, features of heartbeat notifications or alive-monitoring packets exchanged by broadcasting or multicasting between or among certain apparatuses (for example, between apparatuses A and B in FIG. 1) can be controlled. In this way, a flow of these packets can be controlled, and the impact on the network and other apparatuses (for example, an apparatus C in FIG. 1) caused by the exchange of these packets can be reduced.

### First Exemplary Embodiment

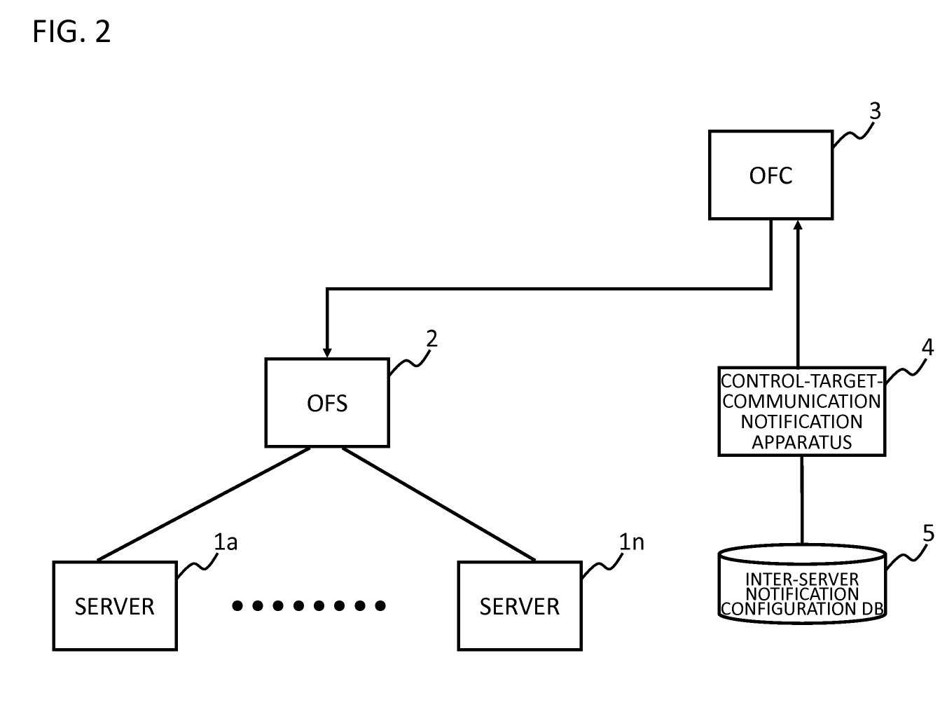

Next, a first exemplary embodiment of the present invention will be described in detail with reference to the drawings. FIG. 2 illustrates a configuration of a computer system according to the first exemplary embodiment of the present invention. FIG. 2 illustrates a configuration in which a plurality of servers 1a to 1n, OpenFlow switches (OFSs) 2 (only one OFS is illustrated in FIG. 2), an OpenFlow controller (hereinafter, referred to as an “OFC”) 3, a control-target-communication notification apparatus 4, and an inter-server notification configuration database (inter-server notification configuration DB) 5 are connected.

Each of the servers 1a to 1n is a computer that performs various calculations and performs broadcasting to transmit heartbeat notifications or alive-monitoring packets (hereinafter, referred to as “certain packets”) to the other servers. Such a certain packet indicates an operation state and whether processing is continuing.

An OpenFlow switch disclosed in Non-Patent Literatures 1 and 2 is used as each of the OFSs 2. An individual OFS 2 holds an entry(ies) in which match conditions (rules) against which headers and the like of received packets are matched and a processing content(s) applied to packets that match the match conditions (rules) are associated with each other. In addition, an individual OFS 2 processes received packets on the basis of its own entry(ies). In place of the OFSs, other switches may be used if such switches can identify and process received packets in accordance with control information set by a control apparatus.

An OpenFlow controller disclosed in Non-Patent Literatures 1 and 2 is used as the OFC 3. The OFC 3 controls the OFSs 2. When receiving a packet from any one of the OFSs 2, the packet being issued from one of the servers 1a to 1n, the OFC 3 according to the present exemplary embodiment refers to a notification forwarding table (described below) and determines a forwarding destination(s) of the packet. Next, the OFC 3 sets a flow entry, which is control information that defines processing for forwarding the packet to the forwarding destination(s), in the OFS(s) 2 on the forwarding path(s) of the packet.

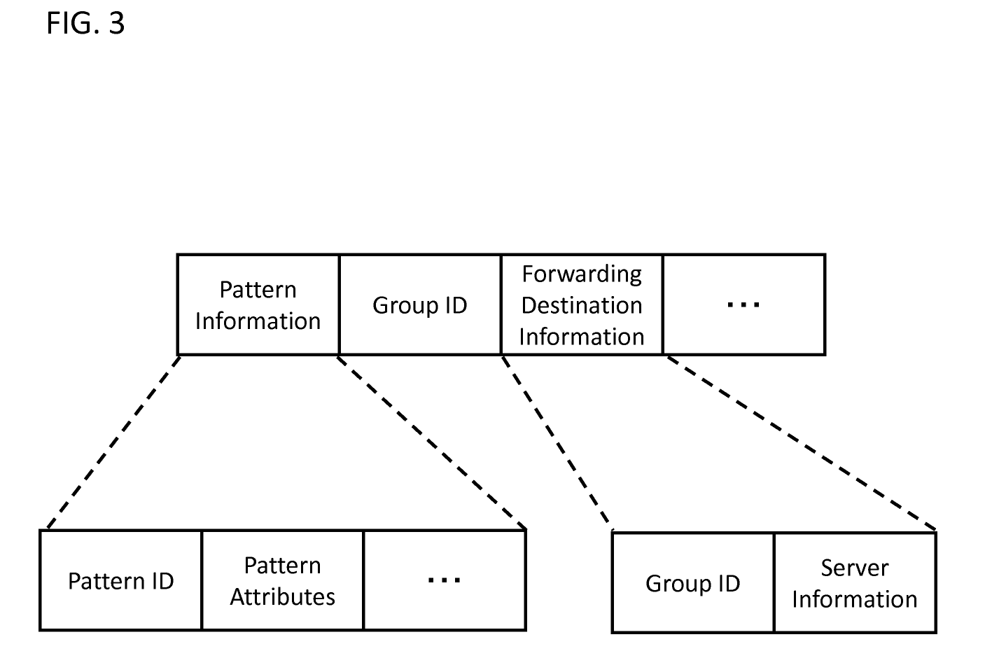

The inter-server notification configuration DB 5 is a database in which forwarding destinations set among the servers 1a to 1n are recorded. FIG. 3 illustrates an exemplary entry held in the inter-server notification configuration DB 5. As illustrated in FIG. 3, the entry includes: “Pattern Information” indicating features of a packet to be controlled; “Group ID” indicating a group to which a communication determined by the corresponding “Pattern Information” belongs; and “Forwarding Destination Information” indicating a corresponding forwarding destination(s). These items of information are associated with each other.

The pattern information includes a pattern ID, which is a pattern identifier, and a group of zero or more pattern attributes, which are associated information about the corresponding pattern. As a pattern attribute, a header field against which a received packet is matched and a corresponding value are set.

In addition, the group ID is an ID given on the basis of a segmentation unit. For example, the group ID is given to a network such as a subnet, a tenant, a partition, and a VLAN or to a resource lending unit.

The forwarding destination information includes a group ID indicating a group serving as a forwarding destination(s) and server information. In addition, a value indicating that all the groups are forwarding targets may be allocated as a certain group ID. In the forwarding destination information field, zero or more forwarding destinations can be set. If no forwarding destinations are set in the entry, corresponding communication packets will be dropped. In addition, as the server information, a media access control (MAC) address (Ether address) of an individual forwarding destination server is set.

Such entry described above is registered in the inter-server notification configuration DB 5 by a network administrator or the like.

Next, a specific configuration of each of the above apparatuses will be described.

### [OFS]

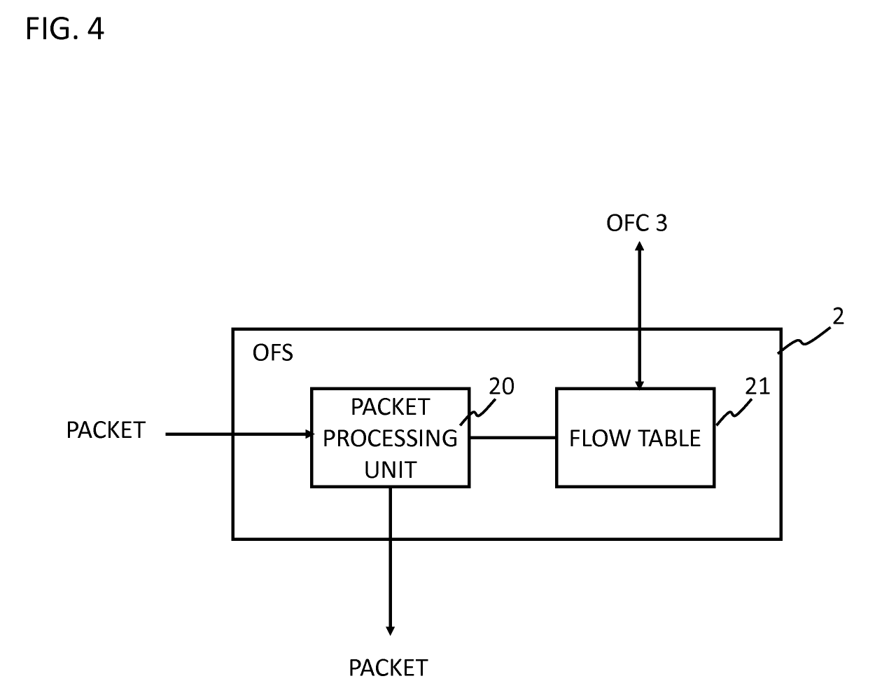

FIG. 4 illustrates a configuration of one of the OFSs 2 according to the first exemplary embodiment of the present invention. As illustrated in FIG. 4, the OFS 2 includes a packet processing unit 20 that processes packets and a flow table 21.

When the OFS 2 receives a packet, the packet processing unit 20 refers to the flow table 21 and processes the received packet. If the flow table 21 does not include any entry that matches the received packet, the packet processing unit 20 forwards the received packet to the OFC 3. If an entry that matches the received packet specifies forwarding the received packet to the OFC 3, the packet processing unit 20 also forwards the received packet to the OFC 3.

The flow table 21 stores an entry(ies) (a flow entry(ies)) in which rules (match conditions) for determining a control target packet and a processing content(s) applied to packets that match the rules (match conditions) are written.

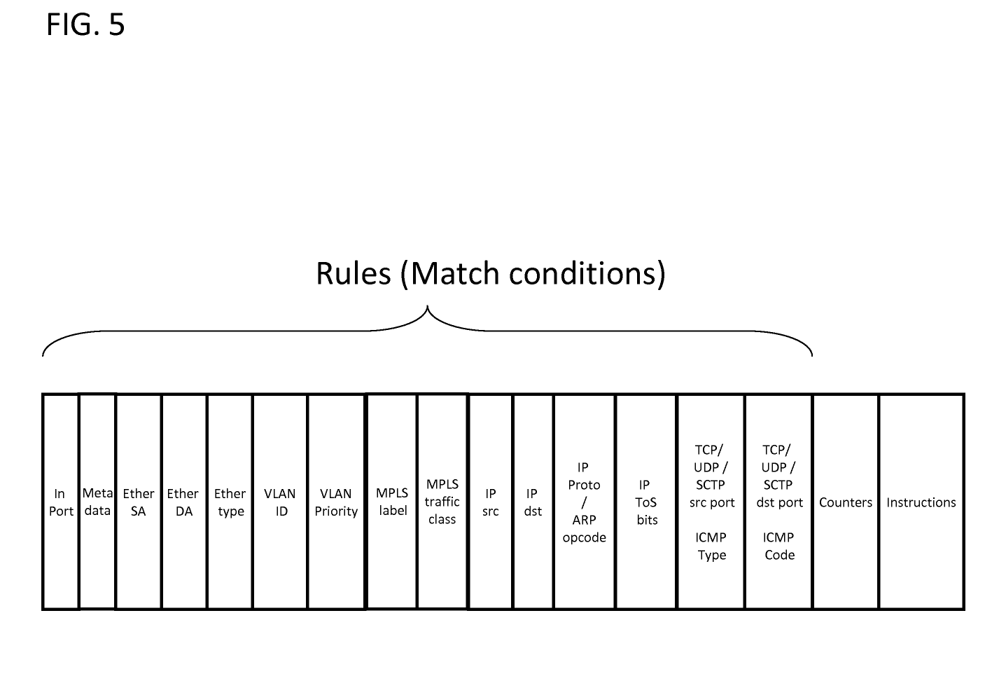

FIG. 5 illustrates an exemplary entry held in the flow table 21. As illustrated in FIG. 5, the entry includes: rule fields (Match Conditions) in which rules against which packet headers or the like of received packets are matched are stored; a flow statistical information field (Counters) in which statistical information about packets or the like that match the rules (match conditions) is stored; and an instruction field (Instructions) in which a processing content(s) (Action) applied to packets that match the rules (match conditions) is stored. These fields are associated with each other. In addition, a wildcard may be set as any one of the rules (match conditions).

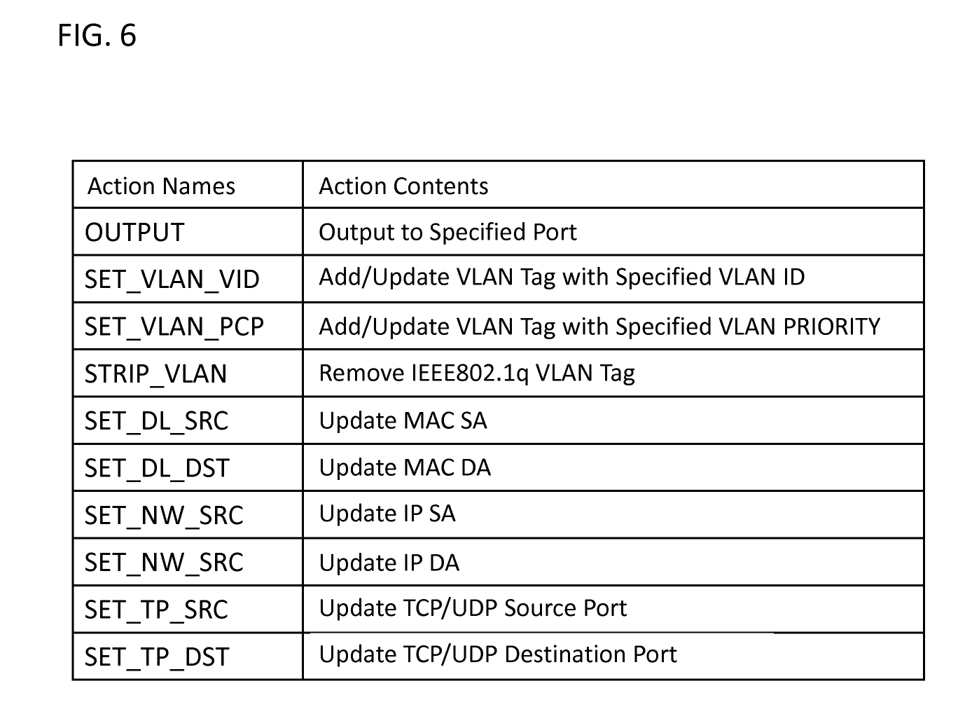

FIG. 6 illustrates exemplary processing contents (Actions) that can be set in the instruction field (Instructions). OUTPUT is an action for outputting a received packet to a specified port (interface). SET_VLAN_VID to SET_TP_DST are actions for modifying packet header fields. These processing contents can be combined and set in the instruction field. For example, it is possible to set processing contents for rewriting the VLAN ID of a packet addressed from a certain source to a certain destination and outputting the packet from a specified port.

The above flow table 21 may be configured by using a content-addressable memory (CAM) or the like. In addition, if the packet processing unit 20 is configured with an application specific integrated circuit (ASIC) that searches the CAM for an entry to perform processing, the packet processing unit 20 can perform the processing at high speed.

### [OFC]

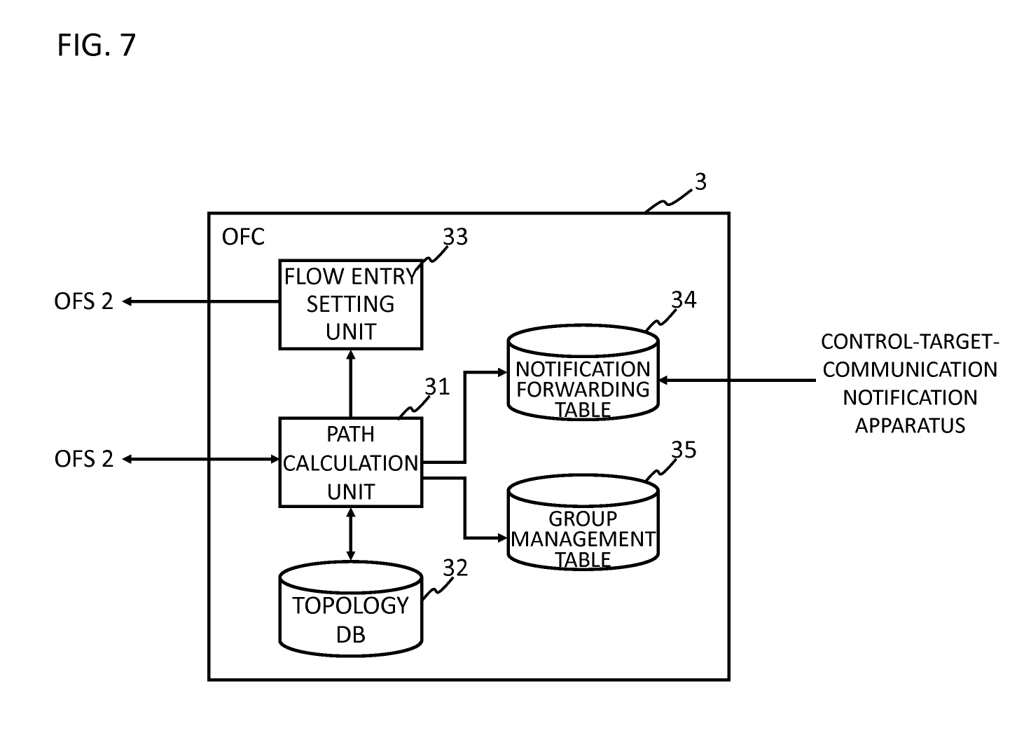

FIG. 7 illustrates a configuration of the OFC 3. As illustrated in FIG. 7, the OFC 3 includes a path calculation unit 31, a topology database (topology DB) 32, a flow entry setting unit 33, a notification forwarding table 34, and a group management table 35.

The path calculation unit 31 is processing means for processing packets transmitted from the OFSs 2. The path calculation unit 31 corresponds to the above communication identification unit.

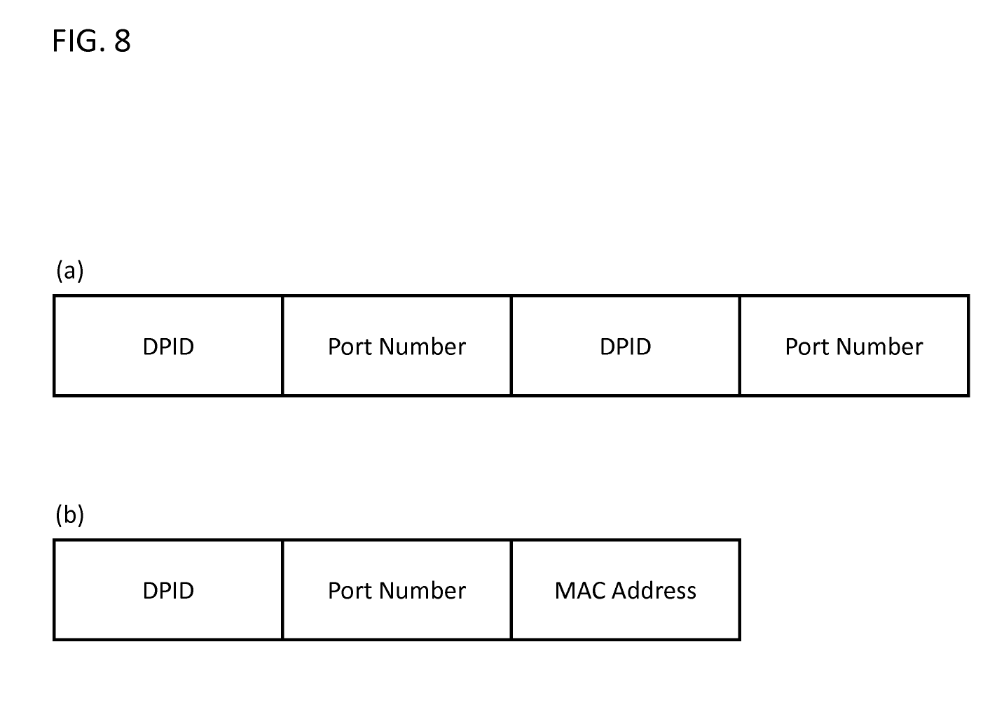

The topology DB 32 is a database for managing topology information that indicates connection relationships among servers 1 and the OFCs 2 (hereinafter, any one of the servers 1a to 1n will be referred to as a “server 1” unless the servers 1a to 1n need to be distinguished from each other). FIG. 8 illustrates exemplary entries held in the topology DB 32. The upper portion (a) of FIG. 8 illustrates an entry that indicates a connection relationship between two OFSs 2. In this entry, the connection relationship is represented by a set of datapath IDs (DPIDs) and corresponding connection ports. A datapath ID is an identifier of an OFS. The lower portion (b) of FIG. 8 illustrates an entry that indicates a connection relationship between an OFS 2 and a server 1. In this entry, the OFS is represented by its DPID and a corresponding connection port and the server is represented by a MAC address of a network interface card (NIC) of the server.

The flow entry setting unit 33 is processing means that performs communication for setting flow entries in the flow tables 21 of the OFSs 2. The flow entry setting unit 33 corresponds to the above switch control unit.

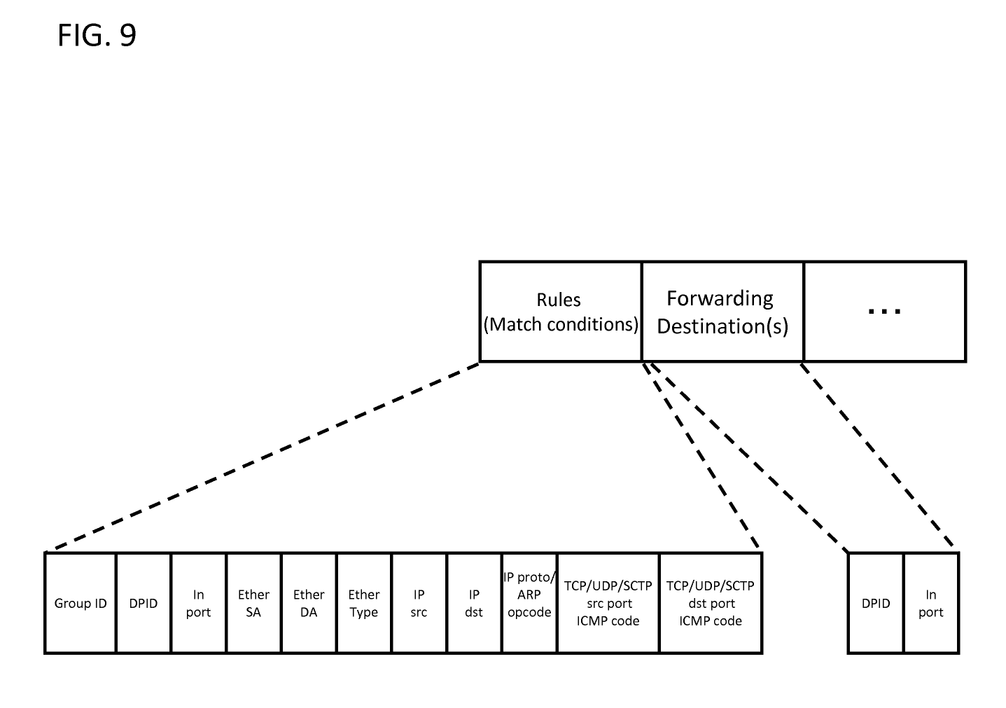

The notification forwarding table 34 is a table for holding an entry(ies) in which features of a certain packet exchanged between or among servers 1 are associated with a corresponding forwarding destination(s) of the packet, the entry(ies) having been supplied from the control-target-communication notification apparatus 4. FIG. 9 illustrates an exemplary entry stored in the notification forwarding table 34. As illustrated in FIG. 9, the entry includes: “Rules (Match Conditions)” and zero or more “forwarding destinations.” If no forwarding destinations are set in the entry, the OFC 3 creates a flow entry for dropping packets that match the corresponding “Rules” and sets the created flow entry in the corresponding OFS 2.

For example, the following information can be specified in the rule fields: a group ID indicating a group to which a server 1 serving as the corresponding communication source belongs; the DPID of the corresponding OFS 2 to which the control target communication packet is inputted; information about the corresponding input port (In port); and other information included in the packet header of the control target communication packet, such as the source MAC address (Ether SA), destination MAC address (Ether DA), Ether type, source IP address (IP src), destination IP address (IP dst), IP (Internet protocol)/ARP number (IP proto/ARP opcode), TCP (transmission control protocol)/UDP (user datagram protocol)/SCTP (stream control transmission protocol) source port number, ICMP (internet control message protocol) code (TCP/UDP/SCTP src port ICMP Code), and TCP/UDP/SCTP des port ICMP code. In addition, a value (wildcard) indicating that any value is applicable or a mask indicating that only a part of a value is valid may be set in an individual field.

The forwarding destination field specifies a forwarding destination determined by the DPID of a corresponding exit-side OFS 2 that is connected to a forwarding destination server and information about the corresponding output port (Out port) of the OFS 2.

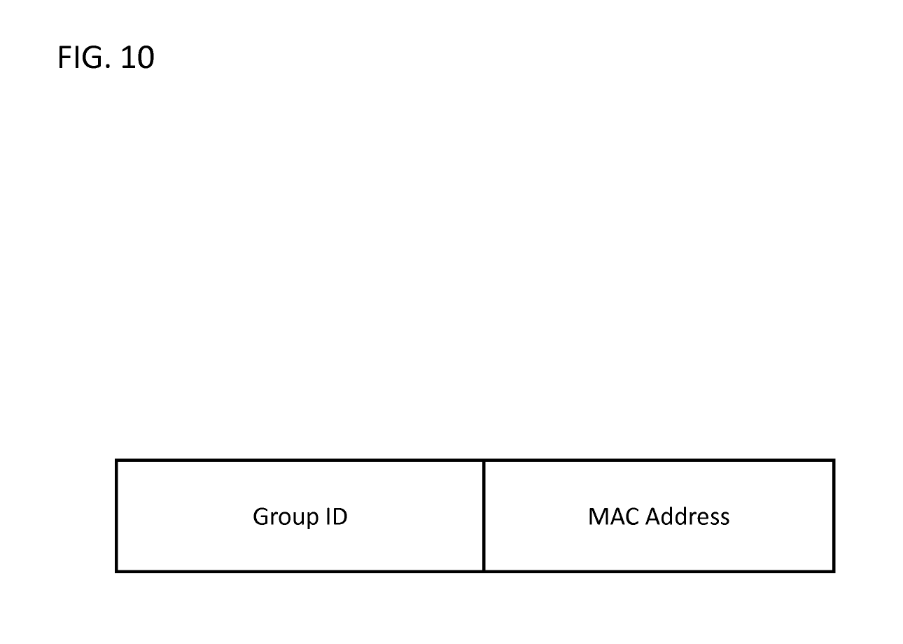

The group management table 35 is a table for managing information about which group each server 1 belongs to. FIG. 10 illustrates an exemplary entry held in the group management table 35. As illustrated in FIG. 10, in each entry, “Group ID” indicating a group and “MAC Address” of a NIC of the server that belongs to the group are associated with each other.

### [Control-Target-Communication Notification Apparatus]

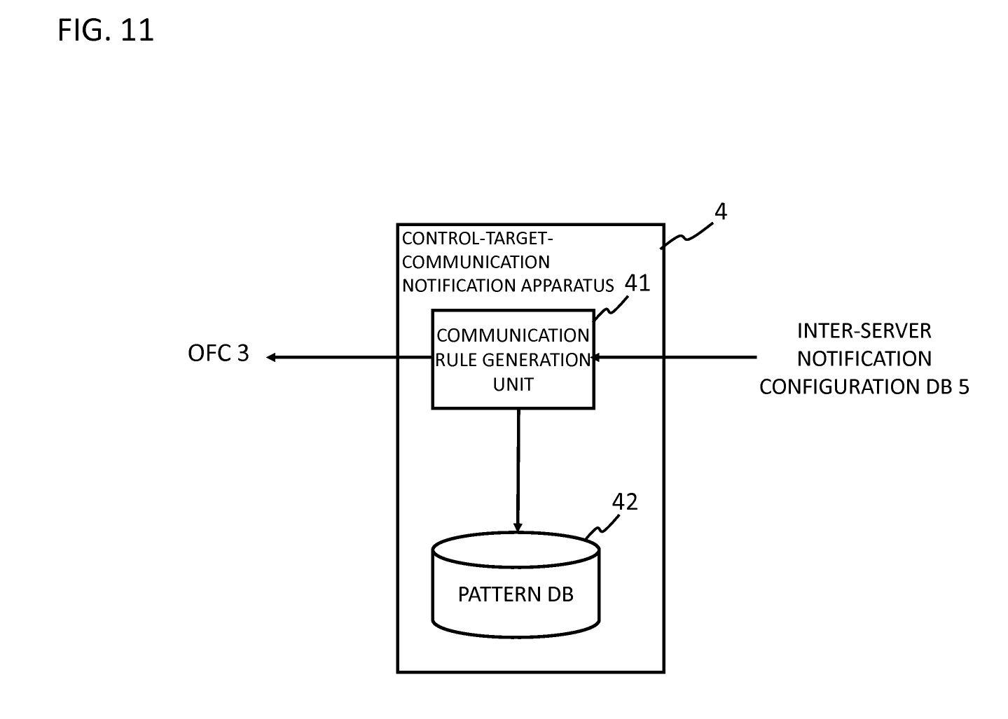

FIG. 11 illustrates a configuration of the control-target-communication notification apparatus 4 according to the first exemplary embodiment of the present invention. As illustrated in FIG. 11, the control-target-communication notification apparatus 4 includes a communication rule generation unit 41 and a pattern database (pattern DB) 42.

The communication rule generation unit 41 converts an entry acquired from the inter-server notification configuration DB 5 by referring to the pattern DB 42 and generates an entry to be registered in the notification forwarding table 34 of the OFC 3.

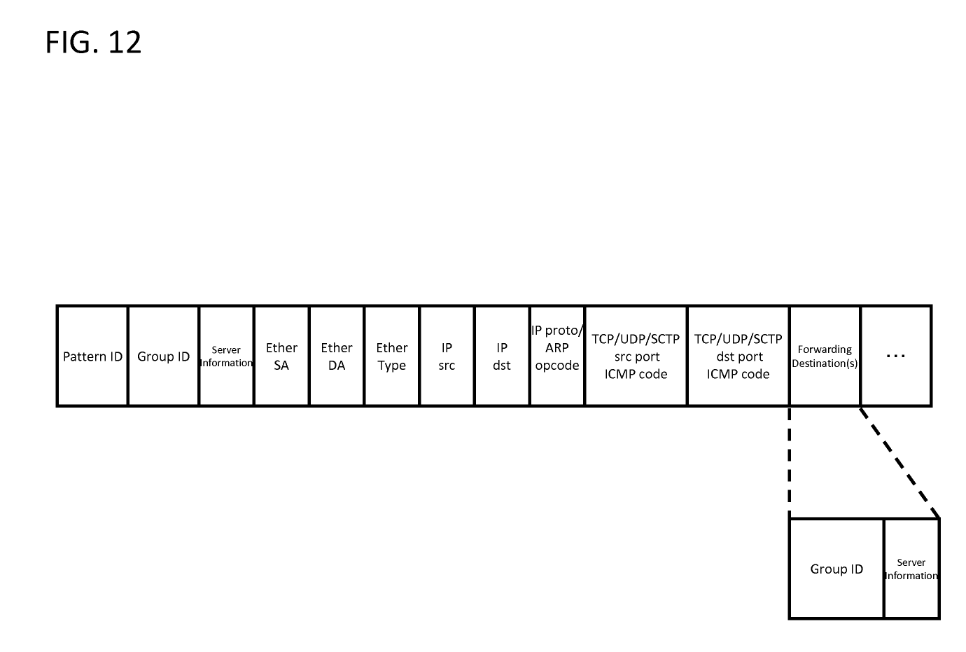

FIG. 12 illustrates an exemplary entry held in the pattern DB 42. As illustrated in FIG. 12, in the entry held in the pattern DB 42, “Pattern ID” for identifying a pattern, “Group ID,” “Server Information,” “Ether SA,” “Ether DA,” “Ether Type,” “IP src,” “IP dst,” “IP proto/ARP opcode,” “TCP/UDP/SCTP src port ICMP Code,” “TCP/UDP/SCTP dst port ICMP Code,” and zero or more forwarding destinations are associated with each other. In addition, a value (wildcard) indicating that any value is applicable or a mask indicating that only a part of a value is valid may be set in an individual field.

In the forwarding destination field, a group ID as a forwarding destination(s) and server information can be set. If no forwarding destinations are set, corresponding communication packets will be dropped. In addition, a group other than the group to which the source server belongs may be set as a forwarding destination. In such case, corresponding communication packets are also forwarded to this group specified by the group ID. By using such entry, the OFC 3 can manage packets to be broadcasted to a plurality of groups in a centralized manner. Since the contents of the other fields in the entry held in the pattern DB 42 are the same as those held in the notification forwarding table 34, description thereof will be omitted.

Each unit (processing means) of the above apparatuses may be realized by a computer program which causes a computer that constitutes the corresponding apparatus to use its hardware and execute the corresponding processing described above.

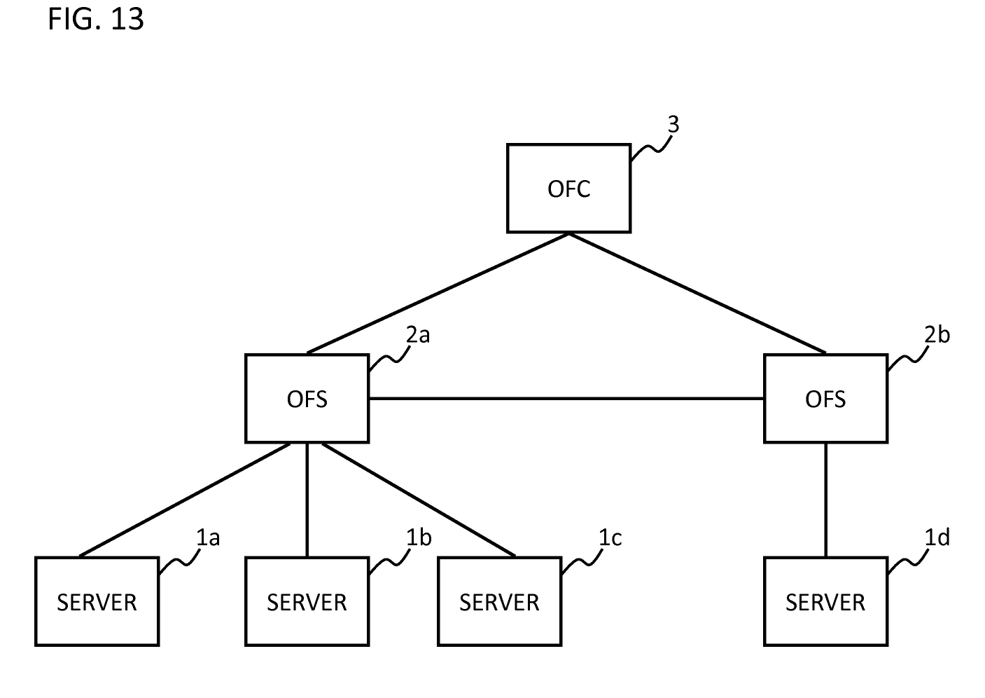

Next, an operation according to the present exemplary embodiment will be described in detail with reference to the drawings. The following description will be made assuming that the servers 1, the OFSs 2, and the OFC 3 are connected as illustrated in FIG. 13.

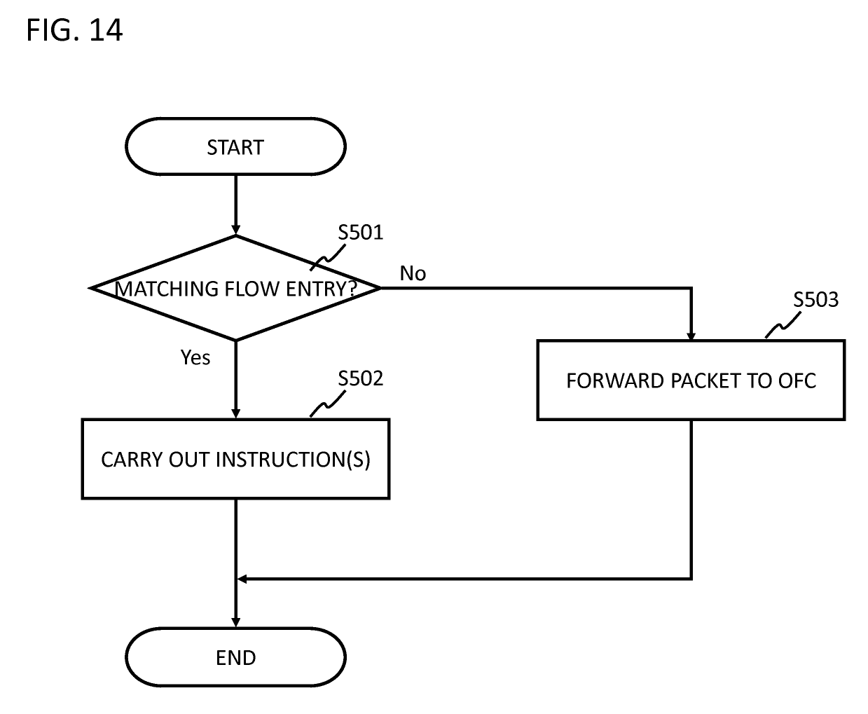

First, a basic operation of an OFS 2 and of the OFC 3 will be described. FIG. 14 is a flowchart illustrating a basic operation of an OFS 2 according to the first exemplary embodiment of the present invention. As illustrated in FIG. 14, when receiving a packet, the packet processing unit 20 of the OFS 2 searches the flow table 21 for an entry having rules (match conditions) that match the received packet (step S501).

As a result of the search, if the packet processing unit 20 finds an entry having rules (match conditions) that match the received packet (Yes in step S501), the OFS 2 carries out a processing content(s) (action(s)) set in the instruction field of the entry (step S502).

If the packet processing unit 20 does not find an entry having rules (match conditions) that match the received packet (No in step S501), the OFS 2 forwards the received packet to the OFC 3 (step S503).

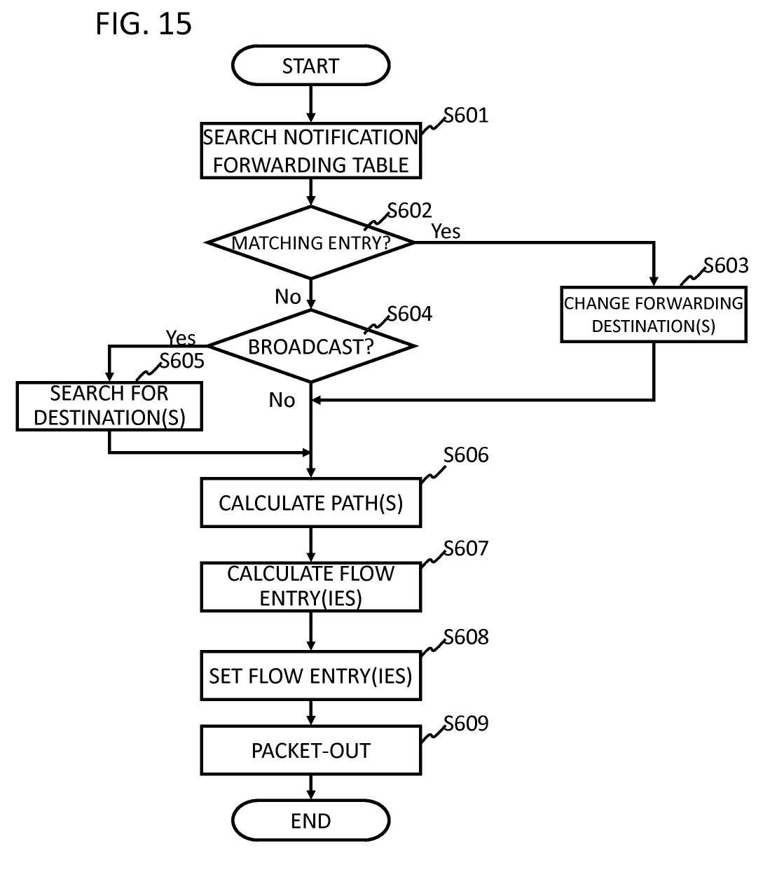

FIG. 15 is a flowchart illustrating an operation of the OFC 3 according to the first exemplary embodiment of the present invention. As illustrated in FIG. 15, when receiving a packet from an OFC 2, the OFC 3 stores a destination(s) specified in the packet header as a destination(s) of the packet. Next, on the basis of information about the OFS 2 that has transmitted the packet, the contents of the packet header, and the group management table 35, the OFC 3 searches the notification forwarding table 34 for an entry having “rules” that match the information (step S601).

As a result of the search, if the OFC 3 finds a matching entry (Yes in step S602), the OFC 3 sets a destination(s) specified in the matching entry as a destination(s) of the packet (step S603; change forwarding destination).

If the OFC 3 does not find a matching entry (No in step S602), the OFC 3 determines whether the received packet is a broadcast packet (step S604). If the received packet is a broadcast packet, the OFC 3 searches the group management table 35 for the other servers that belong to the group to which the source server of the packet belongs and sets these servers as destinations of the packet (step S605).

If the notification forwarding table 34 does not include any entry that matches the received packet and if the received packet is not a broadcast packet (No in step S604), the OFC 3 determines that the received packet is a unicast packet or the like. In such case, the OFC 3 sets the destination that is specified in the packet header and that has been stored in step S601 as the destination of the packet.

Next, by referring to the topology DB 32, the OFC 3 calculates a packet forwarding path(s) from the OFS 2 that has transmitted the packet to the set packet destination(s) (step S606). If the packet has a plurality of forwarding destinations, the OFC 3 calculates respective forwarding paths in the path calculation in step S606. Dijkstra's algorithm may be used for the path calculation.

Next, the OFC 3 calculates a flow entry(ies) to be set in the OFS(s) 2 on the packet forwarding path(s) (step S607) and sets the calculated flow entry(ies) in the corresponding OFS(s) 2 (step S608). In step S607, the OFC 3 can create rules (match conditions) for the flow entry(ies) by using a packet header field(s) that matches the entry in the notification forwarding table 34 (except for a field(s) indicating a wildcard), Ether src, and Ether dst. A wildcard can be used for the rest of the fields. Alternatively, the OFC 3 may create rules (match conditions) for the flow entry(ies) by using a wildcard only for In port and using the original packet header contents for the rest of the fields.

Next, the OFC 3 instructs the OFS 2 to transmit the received packet (step S609). In step S609, if the packet has a single destination, the OFC 3 instructs the OFS 2 connected to the destination to transmit the packet to the destination. If the packet has a plurality of destinations, the OFC 3 instructs the OFS 2 that has transmitted the packet to transmit the packet along the set paths.

Next, an overall operation of the computer system according to the present exemplary embodiment will be described with reference to the drawings. The following description will be made assuming that the servers 1a to 1c belong to a group whose group ID is 1 and that the server 1d belongs to a group whose group ID is 2.

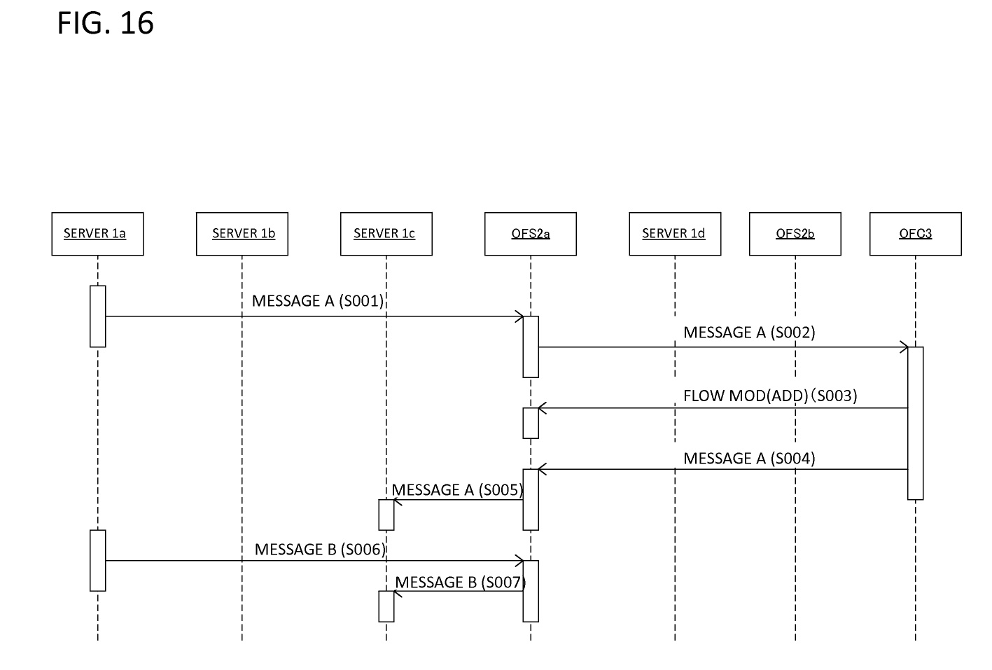

FIG. 16 illustrates a sequence performed when a unicast communication from the server 1a to the server 1c occurs. When the OFS 2a receives a unicast packet (message A) addressed to the server 1c from the server 1a, the OFS 2a forwards the received unicast packet (message A) to the OFC 3 (S001 and S002 in FIG. 16). Since the notification forwarding table 34 does not include an entry that matches the received packet and since the received packet is not a broadcast packet (No in step S602 and No in step S604 in FIG. 15), the OFC 3 calculates a path to the destination of the received packet and sets a flow entry (FLOW MOD (ADD) (S003) in FIG. 16). In addition, the OFC 3 instructs the OFS 2a to transmit the received unicast packet (message A) (S004 in FIG. 16). In accordance with the instruction from the OFC 3, the OFS 2a transmits the received unicast packet (message A) to the server 1c (S005 in FIG. 16). Thereafter, the OFS 2a directly forwards a subsequent packet (message B) to the server 1c in accordance with the flow entry set in step S003 in FIG. 16 (steps S006 and S007 in FIG. 16).

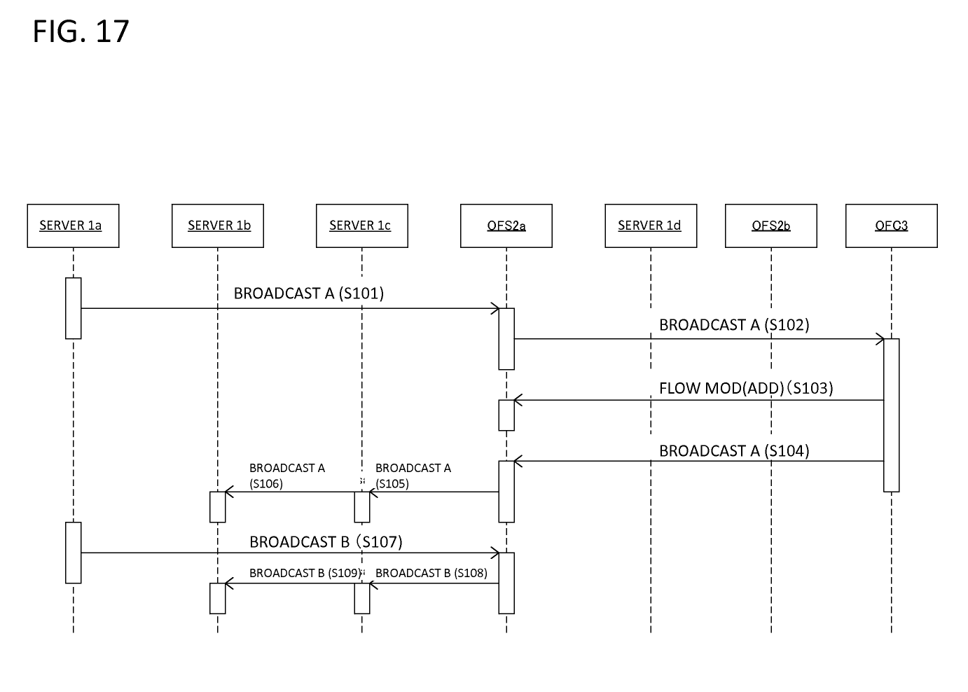

FIG. 17 illustrates a sequence performed when a broadcast communication from the server 1a occurs and when forwarding of the corresponding broadcast packets is not specified by the control-target-communication notification apparatus 4. When the OFS 2a receives a broadcast packet (broadcast A) from the server 1a, the OFS 2a forwards the received broadcast packet (broadcast A) to the OFC 3 (S101 and S102 in FIG. 17). Since the notification forwarding table 34 does not include a flow entry that matches the received packet and since the received packet is a broadcast packet (Yes in step S604 in FIG. 15), the OFC 3 sets the servers that belong to the same group as the source server as the destinations of the broadcast packet (step S605 in FIG. 15). Next, the OFC 3 calculates paths to the respective destinations and sets a corresponding flow entry (FLOW MOD (ADD) (S103) in FIG. 17). In addition, the OFC 3 instructs the OFS 2a to transmit the received broadcast packet (broadcast A) (S104 in FIG. 17). In accordance with the instruction from the OFC 3, the OFS 2a transmits the received broadcast packet (broadcast A) to each of the servers 1b and 1c (S105 and S106 in FIG. 17). Thereafter, the OFS 2a directly forwards a subsequent packet (broadcast B) to each of the servers 1b and 1c in accordance with the flow entry set in S103 in FIG. 17 (steps S107 to S109 in FIG. 17).

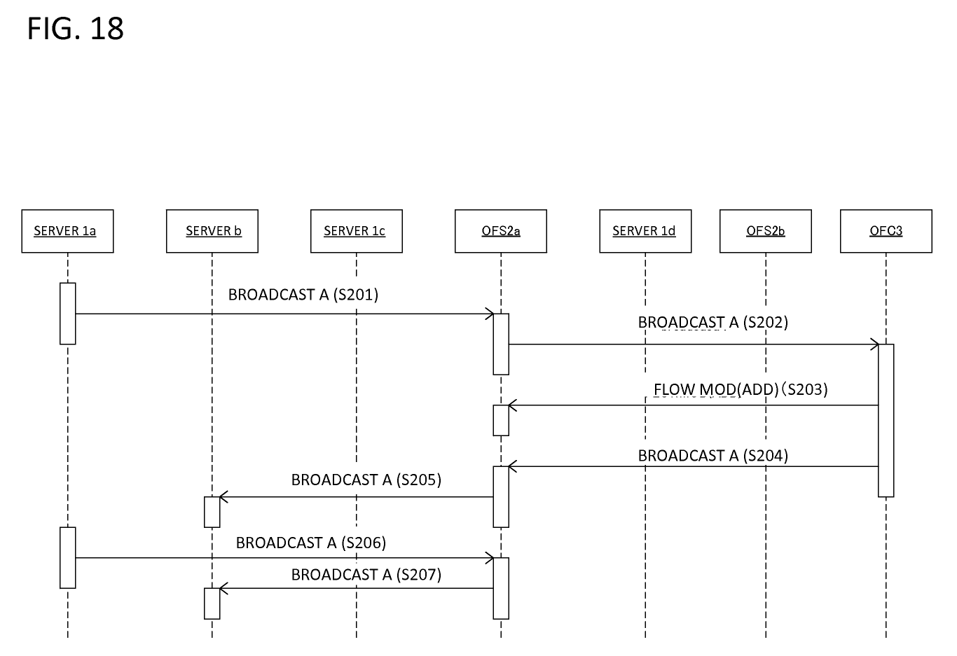

FIG. 18 illustrates a sequence performed when a broadcast communication from the server 1a occurs and when forwarding of the corresponding broadcast packets to the server 1b is specified in an entry added in the notification forwarding table 34 by the control-target-communication notification apparatus 4. When the OFS 2a receives a broadcast packet (broadcast A) from the server 1a, the OFS 2a forwards the received broadcast packet (broadcast A) to the OFC 3 (S201 and S202 in FIG. 18). Since the notification forwarding table 34 includes an entry that matches the received packet (Yes in step S602 in FIG. 15), the OFC 3 calculates a path to the server 1b, which is specified in the matching entry in the notification forwarding table 34, and sets a flow entry (FLOW MOD (ADD) (S203) in FIG. 18). In addition, the OFC 3 instructs the OFS 2a to transmit the received broadcast packet (broadcast A) (S204 in FIG. 18). In accordance with the instruction from the OFC 3, the OFS 2a transmits the received broadcast packet (broadcast A) to the server 1b (S205 in FIG. 18). Thereafter, the OFS 2a directly forwards a subsequent packet (broadcast B) to the server 1b in accordance with the flow entry set in S203 in FIG. 18 (steps S206 and S207 in FIG. 18). As described above, there are cases in which a forwarding destination(s) has been specified in an entry added to the notification forwarding table 34. In such cases, even when a communication of a broadcast packet occurs, among the servers that belong to the same group as the source server, corresponding packets are not forwarded to a server(s) that is not set as the destination(s) (in this case, the server 1c).

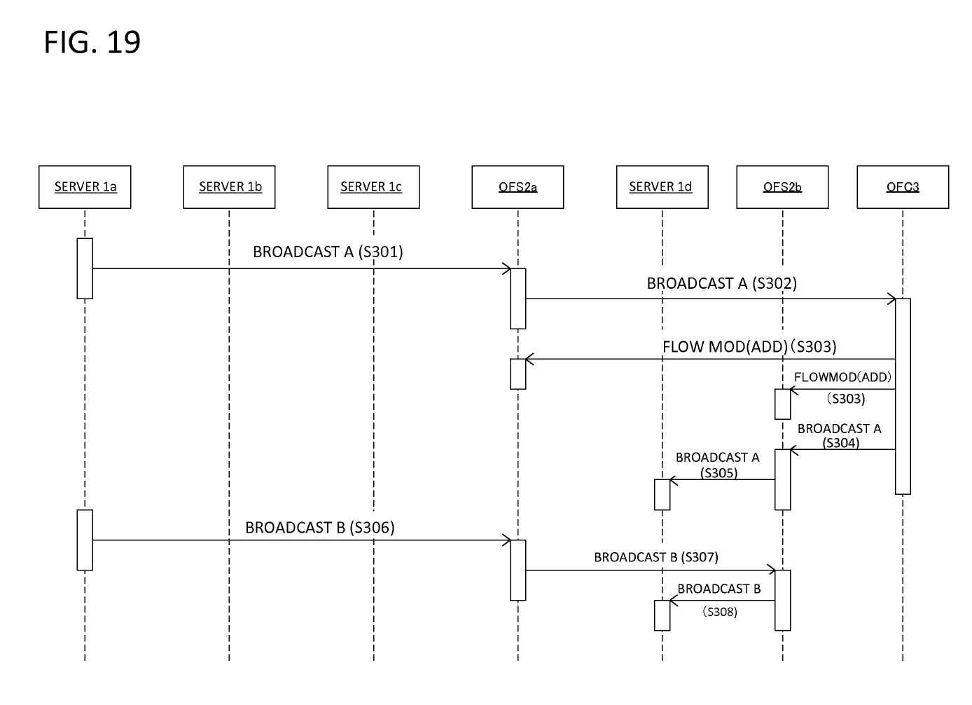

FIG. 19 illustrates a sequence performed when a broadcast communication from the server 1a occurs and when forwarding of the corresponding broadcast packets to the server 1d is specified in an entry added in the notification forwarding table 34 by the control-target-communication notification apparatus 4. When the OFS 2a receives a broadcast packet (broadcast A) from the server 1a, the OFS 2a forwards the received broadcast packet (broadcast A) to the OFC 3 (S301 and S302 in FIG. 19). Since the notification forwarding table 34 includes an entry that matches the received packet (Yes in step S602 in FIG. 15), the OFC 3 calculates a path to the server 1d specified in the matching entry in the notification forwarding table 34, and sets corresponding flow entries (FLOW MOD (ADD) (S303) in FIG. 18). Since the broadcast packet has a single destination, the OFC 3 instructs the OFS 2b to transmit the received broadcast packet (broadcast A) (S304 in FIG. 19). In accordance with the instruction from the OFC 3, the OFS 2b transmits the received broadcast packet (broadcast A) to the server 1d (S305 in FIG. 19). Thereafter, a subsequent packet (broadcast B) to the server 1d is forwarded via the OFSs 2a and 2b in accordance with the flow entries set in S303 in FIG. 19 (steps S306 to S308 in FIG. 19). As described above, there are cases in which a destination(s) that belongs to a different group is specified in an entry added in the notification forwarding table 34. In such cases, even when a communication of a broadcast packet occurs, among the servers that belong to the same group as the source server, corresponding packets are not forwarded to a server(s) that is not set as the destination(s) (in this case, the servers 1b and 1c).

As described above, according to the present exemplary embodiment, by registering an entry that determines heartbeat notifications or alive-monitoring packets broadcasted between or among the servers 1 in the notification forwarding table 34, the OFC 3 can finely specify a forwarding destination(s) of such communication packets. Thus, the network and irrelevant apparatuses are affected less.

### Second Exemplary Embodiment

Next, a second exemplary embodiment will be described. In the second exemplary embodiment, the OFC includes an additional function so that the OFC can accommodate change and deletion of a control target communication between or among servers.

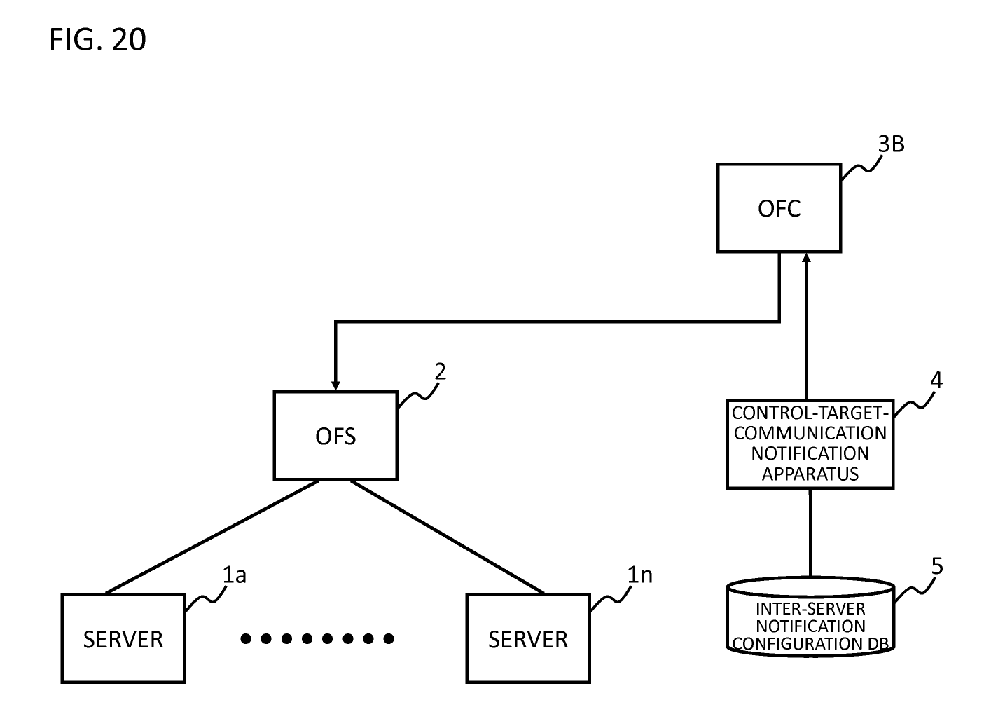

FIG. 20 illustrates a configuration of a computer system according to the second exemplary embodiment of the present invention. FIG. 2 illustrates a configuration in which a plurality of servers 1a to 1n, OFSs 2 (only one OFS is illustrated in FIG. 20), an OFC 3B, a control-target-communication notification apparatus 4, and an inter-server notification configuration DB 5 are connected. Configurations and operations of the servers 1a to 1n, the OFSs 2, and the control-target-communication notification apparatus 4 are the same as those of the corresponding elements in the first exemplary embodiment. The following description will be made with a focus on the difference between the first and second exemplary embodiments.

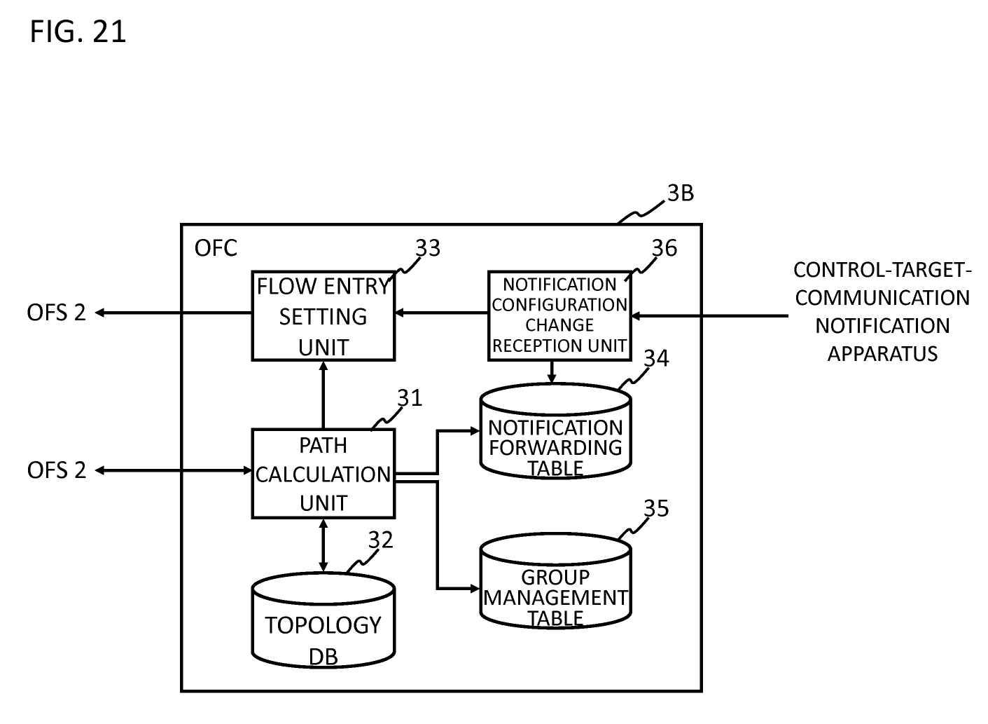

FIG. 21 illustrates a configuration of the OFC 3B according to the second exemplary embodiment. The OFC 3B differs from the OFC 3 according to the first exemplary embodiment illustrated in FIG. 6 in that the OFC 3B includes a notification configuration change reception unit 36 that receives a notification from the control-target-communication notification apparatus 4. Since the other elements denoted by the same reference characters as those in the OFC in FIG. 6 are the same as those of the OFC 3 according to the first exemplary embodiment, description thereof will be omitted.

On the basis of a notification transmitted from the control-target-communication notification apparatus 4, the notification configuration change reception unit 36 modifies the notification forwarding table 34. If a related flow entry(ies) is set in the flow table(s) 21 of the OFS(s) 2, the notification configuration change reception unit 36 requests the flow entry setting unit 33 to delete the related flow entry(ies) from the OFS(s) 2 that includes the related flow entry(ies).

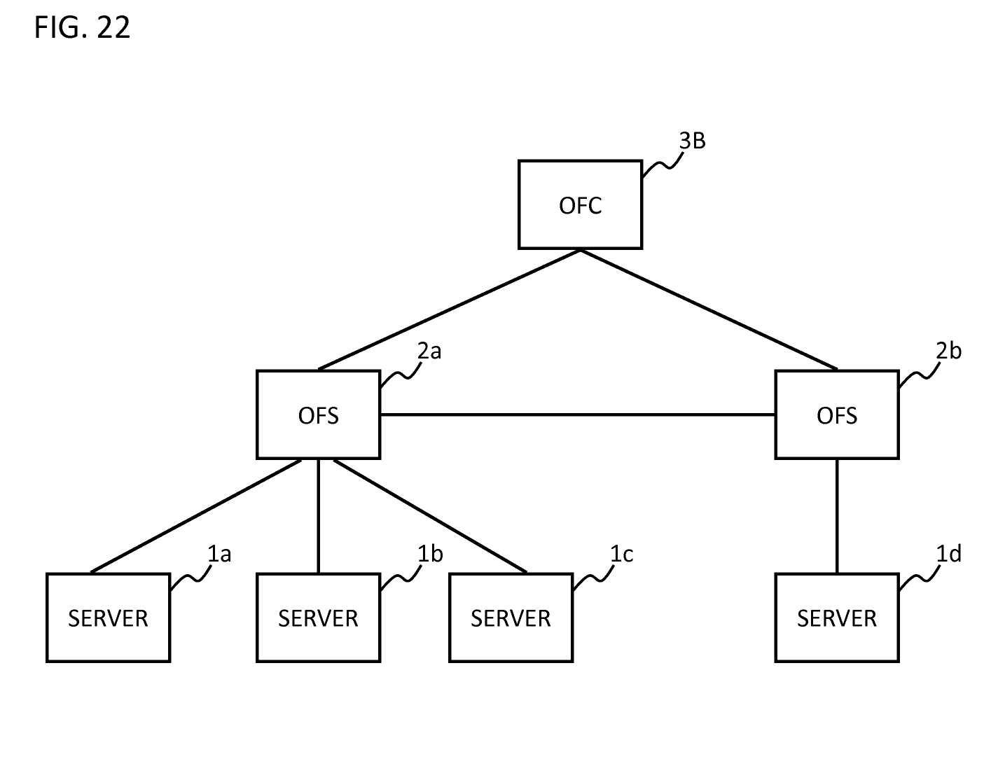

Next, an operation according to the present exemplary embodiment will be described in detail with reference to the drawings. The following description will be made assuming that the servers 1, the OFSs 2 (2a and 2b), and the OFC 3B are connected as illustrated in FIG. 22.

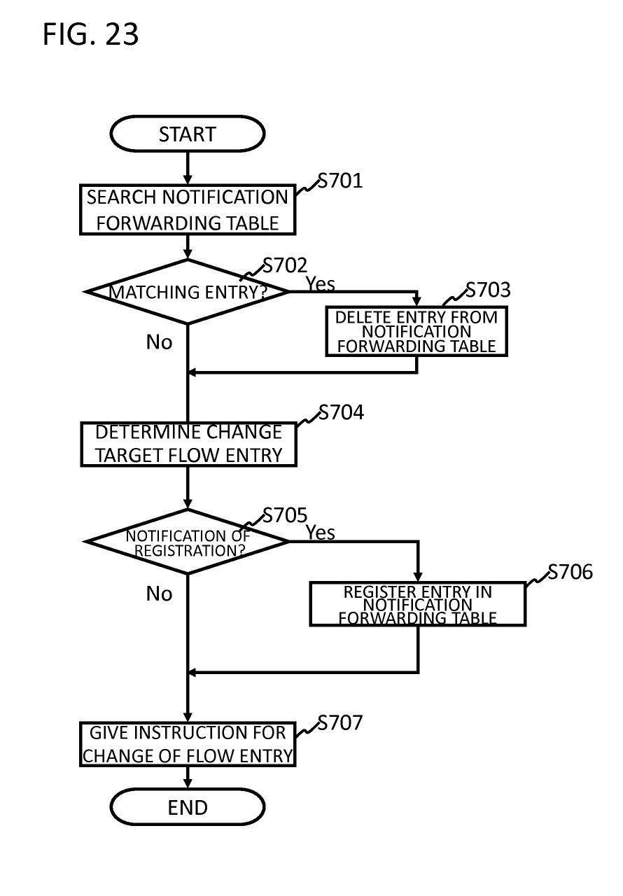

Next, an operation performed by the OFC 3B that has received a notification from the control-target-communication notification apparatus 4 will be described. FIG. 23 is a flowchart illustrating an operation of the OFC 3B according to the second exemplary embodiment of the present invention. As illustrated in FIG. 23, first, the OFC 3B searches the notification forwarding table 34 for an entry that matches rules (match conditions) in the modification target entry indicated by the control-target-communication notification apparatus 4 (step S701).

As a result of the search, if the notification forwarding table 34 includes an entry that matches rules (match conditions) in the modification target entry indicated by the control-target-communication notification apparatus 4 (Yes in step S702), the OFC 3B deletes the entry from the notification forwarding table 34 (step S703).

Next, on the basis of the modification content indicated by the control-target-communication notification apparatus 4, the OFC 3B determines a change to be made to a flow entry(ies) that has been set in the corresponding OFS(s) 2 (step S704). For example, if the control-target-communication notification apparatus 4 instructs the OFC 3B to delete an entry, the OFC 3B determines a corresponding flow entry to be deleted by the flow entry setting unit 33. To determine the deletion-target flow entry, the OFC 3B copies, other than a rule(s) (match condition(s)) indicated by a wildcard, the rules (match conditions) of the corresponding entry held in the notification forwarding table 34 in the relevant rules of a flow entry, sets a wildcard for the rest of the rules, and searching for a flow entry that matches the created rule(s) (match condition(s)). In addition, for example, if the control-target-communication notification apparatus 4 instructs the OFC 3B to change a forwarding destination(s) in an entry, the OFC 3B determines a corresponding flow entry to be changed by the flow entry setting unit 33 and a content(s) of the corresponding instruction field to be changed by the flow entry setting unit 33.

Next, the OFC 3B determines whether the modification content indicated by the control-target-communication notification apparatus 4 is a notification of registration of a new entry in the notification forwarding table 34 (step S705).

As a result of the determination, if the modification indicated by the control-target-communication notification apparatus 4 is a notification of registration of a new entry in the notification forwarding table 34, the OFC 3B registers a new entry in the notification forwarding table 34 (step S706).

Finally, the OFC 3B requests the flow entry setting unit 33 to change or delete the corresponding flow entry (step S707).

If the OFC 3B has a table holding a flow entry(ies) that corresponds to a preset path(s), the OFC 3B can perform the flow entry determination processing in step S704 by referring to this table.

Next, an overall operation of the computer system according to the present exemplary embodiment will be described with reference to the drawings. The following description will be made assuming that the servers 1a to 1c belong to a group whose group ID is 1 and that the server 1d belongs to a group whose group ID is 2.

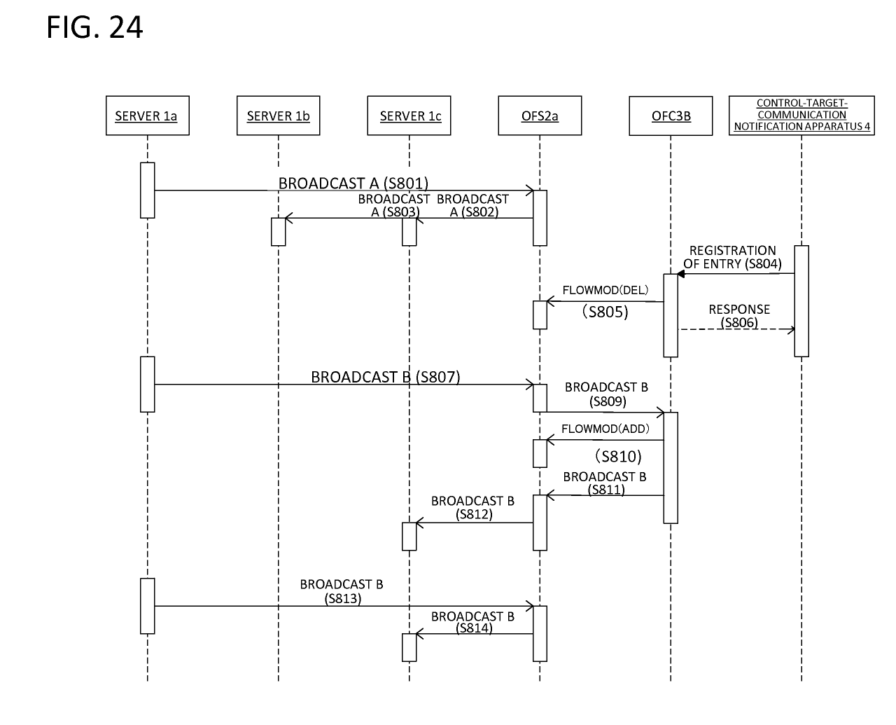

FIG. 24 illustrates a sequence performed when, after the server 1a transmits a broadcast communication, of which the OFC 3B has not been notified by the control-target-communication notification apparatus 4, and after the OFC 3B sets a corresponding flow entry, the OFC 3B receives an instruction for registering an entry in which the server 1c is specified as the forwarding destination of the broadcast packet from the control-target-communication notification apparatus 4. In this case, since the notification forwarding table 34 does not include a matching entry, the OFC 3B does not perform any operation on the notification forwarding table 34 (No in step S702 in FIG. 23). Since, among the flow entries that have already been set in the OFS 2a, there is a flow entry that overlaps with the entry in the notification forwarding table that needs to be registered, the OFC 3B instructs the flow entry setting unit 33 to delete the flow entry (FLOW MOD (DEL) (S805) in FIG. 24). Accordingly, the flow entry for forwarding corresponding broadcast packets from the server 1a to each of the servers 1b and 1c as illustrated in steps S801 to S803 is deleted.

Next, as in the operation according to the first exemplary embodiment illustrated in FIG. 18, when the OFC 3B receives a broadcast packet (broadcast B) from the OFS 2a, the OFC 3B calculates a path to the server 1c and sets a corresponding flow entry in the OFS 2a (FLOW MOD (ADD) (S810) in FIG. 24). In addition, the OFC 3B instructs the OFS 2a to transmit the received broadcast packet (broadcast B) (S811 in FIG. 24). In accordance with the instruction from the OFC 3, the OFS 2a transmits the received broadcast packet (broadcast B) to the server 1c (S812 in FIG. 24). Thereafter, the OFS 2a forwards a subsequent packet (broadcast C) to the server 1c in accordance with the flow entry set in S810 in FIG. 24 (steps S813 and S814 in FIG. 17).

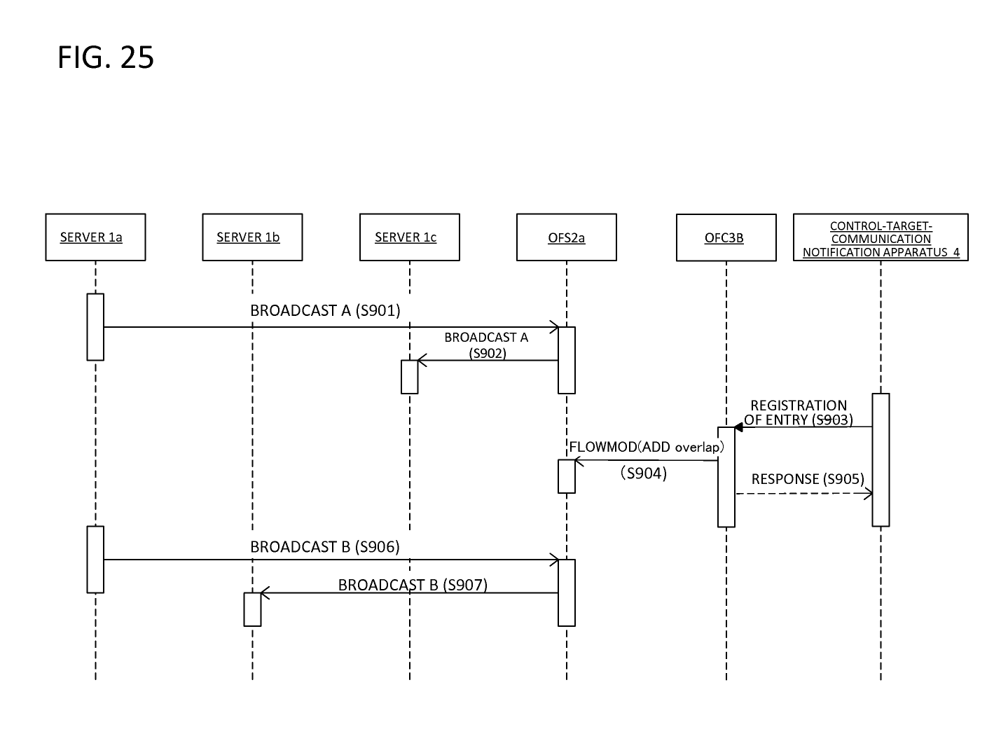

FIG. 25 illustrates a sequence performed when the OFC 3B is instructed by the control-target-communication notification apparatus 4 to register an entry for changing the forwarding destination of the corresponding broadcast packets from the server 1c to the server 1b after the operation in FIG. 24. In this case, since the notification forwarding table 34 includes a matching entry, the OFC 3B deletes this matching entry from the notification forwarding table 34 (step S703 in FIG. 23). Since, among the flow entries that have already been set in the OFS 2a, there is a flow entry that overlaps with the entry in the notification forwarding table 34 that instructs the change of the forwarding destination, the OFC 3B instructs the flow entry setting unit 33 to change the content of the instruction field in the flow entry (FLOW MOD (ADD overlap) (S904) in FIG. 25). Accordingly, a flow entry for forwarding corresponding broadcast packets from the server 1a to the server 1b is set in the OFS 2a. Thereafter, the OFS 2a forwards a subsequent packet (broadcast B) to the server 1b in accordance with the flow entry changed in S904 in FIG. 25 (steps S906 and S907 in FIG. 25).

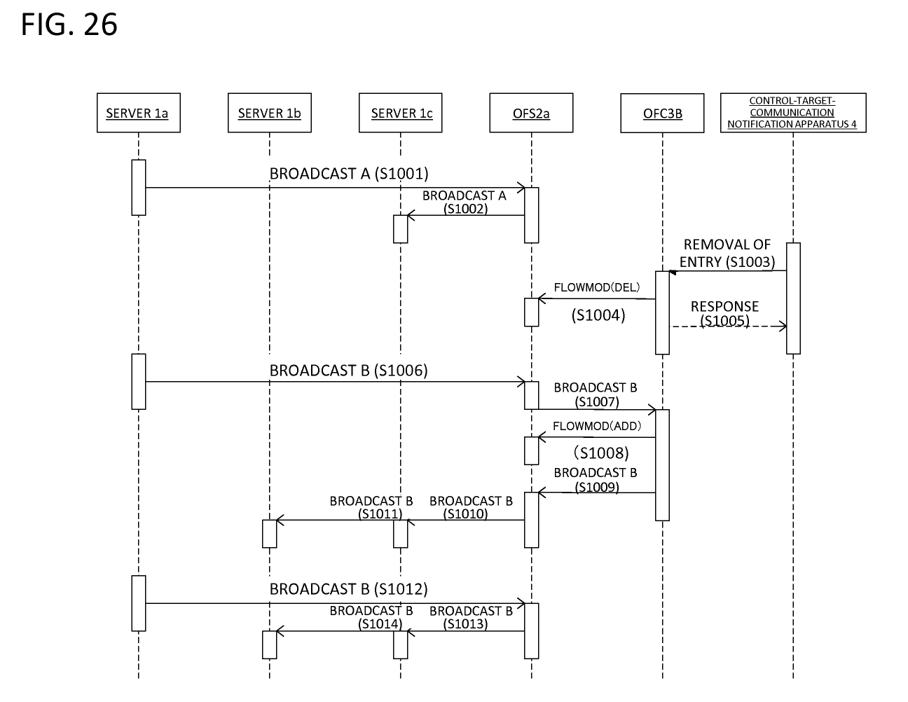

FIG. 26 is a sequence performed when the OFC 3B is instructed by the control-target-communication notification apparatus 4 to delete the entry that specifies the forwarding destination of the broadcast packet after the operation in FIG. 25. In this case, since the notification forwarding table 34 includes a matching entry, the OFC 3B deletes this matching entry from the notification forwarding table 34 (step S703 in FIG. 23). Since, among the flow entries that have already been set in the OFS 2a, there is a flow entry that overlaps with the entry in the notification forwarding table 34 that instructs the change of the forwarding destination, the OFC 3B instructs the flow entry setting unit 33 to delete the flow entry (FLOW MOD (DEL) (S1004) in FIG. 26). Accordingly, the flow entry for forwarding corresponding broadcast packets from the server 1a to the server 1b as illustrated in steps S1001 to S1003 is deleted.

Next, as in the operation according to the first exemplary embodiment illustrated in FIG. 17, when the OFC 3B receives a broadcast packet (broadcast B) from the OFS 2a, the OFC 3B calculates paths to the servers 1b and 1c, and sets a flow entry in the OFS 2a (FLOW MOD (ADD) (S1008) in FIG. 26). In addition, the OFC 3B instructs the OFS 2a to transmit the received broadcast packet (broadcast B) (S1009 in FIG. 26). In accordance with the instruction from the OFC 3, the OFS 2a transmits the received broadcast packet (broadcast B) to each of the servers 1b and 1c (S1010 and S1011 in FIG. 26). Thereafter, the OFS 2a forwards a subsequent packet (broadcast C) to each of the servers 1b and 1c in accordance with the flow entry set in S1008 in FIG. 26 (steps S1012 to S1014 in FIG. 26).

As described above, according to the second exemplary embodiment, on the basis of an operation content given by the control-target-communication notification apparatus 4 on the notification forwarding table 34, the OFC 3B operates a corresponding flow entry. Thus, even a communication whose forwarding destination and the like is frequently changed can be registered in the notification forwarding table 34.

Finally, control target packets as specific examples and corresponding exemplary entries in the pattern DB 42, the inter-server notification configuration DB 5, and the notification forwarding table 34 will be described.

(1) Gratuitous ARP transmitted by BMC watchdog timer when IPMI is used
An example will be described assuming that a method in which notification of a heartbeat is performed by broadcasting a gratuitous ARP packet is used and that all gratuitous ARP packets in a group are forwarded to a certain server included in another group.

In this case, the pattern DB 42 includes an entry as follows. In the following entry, “VAL” is a value indicating that an attribute value is to be set and “WILDCARD” is a value indicating a wildcard. An entry in the pattern DB 42 (

### Pattern ID: i,

### Group ID: VAL,

### DPID: WILDCARD,

In port: WILDCARD,

### Ether SA: WILDCARD,

### Ether DA: FF FF FF FF FF FF,

Ether Type: 0x0806,

### IP src: WILDCARD,

### IP dst: WILDCARD,

IP proto/ARP opcode: 0x0001,
TCP/UDP/SCTP src port ICMP Code: WILDCARD,
TCP/UDP/SCTP dst port ICMP Code: WILDCARD,
Forwarding Destination 1 {Group ID: VAL, Server Information [MAC address]: VAL})

Next, an entry in the inter-server notification configuration DB 5 will be described, the entry being applied to when forwarding is performed from all the servers corresponding to a group ID=G1 to MAC address=Md corresponding to a group ID=G2.

An entry in the notification configuration DB 5 (

### Pattern ID: i,

### Pattern Attribute 1: G1,

### Forwarding Destination Information 1 {Group ID: G2, Server

Information [MAC address]: Md}
)

The control-target-communication notification apparatus 4 creates the following entry to be stored in the notification forwarding table 34 on the basis of the above entries in the pattern DB 42 and the inter-server notification configuration DB 5. In the following entry, the DPID and the output port information (Out port) of the forwarding destination OFS are dp1 and m, respectively.

An entry in the notification forwarding table 34 (

### Rules {

### Group ID: G1,

Server Information [MAC address]: WILDCARD,

### Ether SA: WILDCARD,

### Ether DA: FF FF FF FF FF FF,

Ether Type: 0x0806,

### IP src: WILDCARD,

### IP dst: WILDCARD,

IP proto/ARP opcode: 0x0001,
TCP/UDP/SCTP src port ICMP Code: WILDCARD,
TCP/UDP/SCTP dst port ICMP Code: WILDCARD
},
Forwarding Destination 1 {DPID: dp1, Out port: m})
)

### (2) Linux HA (Heartbeat)

For example, in a situation in which a heartbeat notification is regularly transmitted to specified ports of UDP by broadcasting, an example in which packets are aggregated to a specified server will be described.

In this case, the pattern DB 42 includes an entry as follows. In the following entry, “VAL” is a value indicating that an attribute value is to be set and “WILDCARD” is a value indicating a wildcard.

An entry in the pattern DB 42 (

### Pattern ID: j,

### Group ID: VAL,

### DPID: WILDCARD,

In port: WILDCARD,

### Ether SA: WILDCARD,

### Ether DA: FF FF FF FF FF FF,

Ether Type: 0x0800,

### IP src: WILDCARD,

### IP dst: VAL,

IP proto/ARP opcode: 17,
TCP/UDP/SCTP src port ICMP Code: WILDCARD,
TCP/UDP/SCTP dst port ICMP Code: VAL,
Forwarding Destination 1 {Group ID: VAL, Server Information [MAC address]: VAL}
)

Next, an entry in the inter-server notification configuration DB 5 will be described, the entry being applied to when the communications involving UDP 55000 ports of all the servers corresponding to a group ID=G1 are forwarded to MAC address=Ma in the same group.

An entry in the inter-server notification configuration DB 5 (

### Pattern ID: j,

### Pattern Attribute 1: G1,

### Pattern Attribute 2: WILDCARD,

### Pattern Attribute 3: 55000,

Forwarding Destination Information 1 {Group ID: G1, Server Information [MAC address]: Ma}
)

The control-target-communication notification apparatus 4 creates the following entry to be stored in the notification forwarding table 34 on the basis of the above entries in the pattern DB 42 and the inter-server notification configuration DB 5. In the following entry, the DPID and the output port information (Out port) of the forwarding destination OFS are dp2 and k, respectively.

An entry in the notification forwarding table 34 (

### Rules {

### Group ID: G1,

Server Information [MAC address]: WILDCARD,

### Ether SA: WILDCARD,

### Ether DA: FF FF FF FF FF FF,

Ether Type: 0x0800,

### IP src: WILDCARD,

### IP dst: WILDCARD,

IP proto/ARP opcode: 0x0800,
TCP/UDP/SCTP src port ICMP Code: WILDCARD,
TCP/UDP/SCTP dst port ICMP Code: 55000
},
Forwarding Destination 1 {DPID: dp2, Out port: k}
)

While exemplary embodiments of the present invention have thus been described, the present invention is not limited thereto. Further variations, substitutions, or adjustments can be made without departing from the basic technical concept of the present invention. For example, the configurations of the networks and elements illustrated in the drawings are used only as examples to facilitate understanding of the present invention. Namely, the present invention is not limited to the configurations illustrated in the drawings.

For example, in the above exemplary embodiments, while the OFC 3 or 3B sets a flow entry(ies) when receiving a packet forwarded from an OFS(s) 2, the OFC 3 or 3B may set a flow entry(ies) in the flow table(s) of the OFS(s) 2 in advance. In this way, processing load on the OFC 3 or 3B is reduced, and delay in forwarding an initial packet can be shortened.

In addition, in the above exemplary embodiments, while heartbeat notifications or alive-monitoring packets exchanged between or among servers are used as the control targets, packets exchanged between various types of other apparatuses may be used as the control targets. For example, broadcast/multicast packets exchanged between or among apparatuses called machine to machine (M2M) can be used as the control targets.

Finally, suitable modes of the present invention will be summarized.

### [Mode 1]

(See the control apparatus according to the above first aspect.)

### [Mode 2]

The control apparatus according to mode 1;

wherein the pattern(s) is used for determining a state check packet periodically broadcasted or multicasted between or among the predetermined apparatuses.

### [Mode 3]

The control apparatus according to mode 1 or 2;

wherein the control apparatus holds a table in which the pattern(s) and a corresponding forwarding destination(s) are associated with each other; and

wherein, by referring to the table, the switch control unit creates control information for instructing forwarding of packets that match the pattern(s) to the corresponding forwarding destination(s) and sets the control information at least in the switch.

### [Mode 4]

The control apparatus according to mode 3;

wherein a group to which the forwarding-destination apparatus(s) belongs can be specified as a forwarding destination in the table; and

wherein, by referring to a second table in which information about the apparatus(es) that belongs to the group is stored, the switch control unit determines an apparatus(es) to which packets that match the match conditions are forwarded.

### [Mode 5]

The control apparatus according to mode 3 or 4;

wherein the control apparatus is connected to a control-target-communication notification apparatus that updates the table.

### [Mode 6]

The control apparatus according to mode 5;

wherein, on the basis of deletion of an entry(ies) or change of a forwarding destination(s) in the table by the control-target-communication notification apparatus, the control apparatus updates control information that is at least set in the switch.

### [Mode 7]

(See the computer system according to the above second aspect.)

### [Mode 8]

(See the communication control method according to the above third aspect.)

### [Mode 9]

(See the program according to the above fourth aspect.)

Modes 7 to 9 can be expanded in the same way as mode 1 is expanded to modes 2 to 6.

The disclosure of each of the above Patent Literatures and Non-Patent Literatures is incorporated herein by reference thereto. Modifications and adjustments of the exemplary embodiments and examples are possible within the scope of the overall disclosure (including the claims) of the present invention and based on the basic technical concept of the present invention. In addition, various combinations and selections of various disclosed elements (including the elements in each of the claims, exemplary embodiments, examples, drawings, etc.) are possible within the scope of the entire disclosure of the present invention. Namely, the present invention of course includes various variations and modifications that could be made by those skilled in the art according to the entire disclosure including the claims and the technical concept. In particular, the present description discloses numerical value ranges. However, even if the description does not particularly disclose arbitrary numerical values or small ranges included in the ranges, these values and ranges should be deemed to have been specifically disclosed.

### REFERENCE SIGNS LIST

1, 1a to 1n server
2, 2a, 2b OpenFlow switch (OFS)
3, 3B OpenFlow controller (OFC)
4 control-target-communication notification apparatus
5 inter-server notification configuration database (inter-server
notification configuration DB)
20 packet processing unit
21 flow table
31 path calculation unit
32 topology database (topology DB)

What is claimed is:

1. A control apparatus, comprising:
a communication identification unit that identifies a predetermined communication between or among predetermined apparatuses by matching a packet received via a switch against a preset pattern(s); and
a switch control unit that sets, at least in the switch, control information in which match conditions for determining the predetermined communication between or among the predetermined apparatuses and a processing content(s) applied to the communication between or among the apparatuses are associated with each other.

2. The control apparatus according to claim 1;
wherein the pattern(s) is used for determining a state check packet periodically broadcasted or multicasted between or among the predetermined apparatuses.

3. The control apparatus according to claim 1;
wherein the control apparatus holds a first table in which the pattern(s) and a corresponding forwarding destination(s) are associated with each other; and
wherein, by referring to the first table, the switch control unit creates control information for instructing forwarding of packets that match the pattern(s) to the corresponding forwarding destination(s) and sets the control information at least in the switch.

4. The control apparatus according to claim 3;
wherein a group to which the forwarding-destination apparatus(s) belongs can be specified as a forwarding destination in the first table; and
wherein, by referring to a second table in which information about the apparatus(es) that belongs to the group is stored, the switch control unit determines an apparatus(es) to which packets that match the match conditions are forwarded.

5. The control apparatus according to claim 3;
wherein the control apparatus is connected to a control-target-communication notification apparatus that updates the first table.

6. The control apparatus according to claim 5;
wherein, on the basis of deletion of an entry(ies) or change of a forwarding destination(s) in the first table by the control-target-communication notification apparatus, the control apparatus updates control information that is at least set in the switch.

7. (canceled)

8. (canceled)

9. A communication control method, comprising:
causing a control apparatus, which controls a switch(es) that processes received packets by referring to control information set by the control apparatus, to identify a predetermined communication between or among predetermined apparatuses by matching a packet received via one of the switch(es) against a preset pattern(s); and
causing the control apparatus to set, at least in the switch, control information in which match conditions for determining the predetermined communication between the predetermined apparatuses and a processing content(s) applied to the communication between the apparatuses are associated with each other.

10. (canceled)

11. The control apparatus according to claim 2;
wherein the control apparatus holds a first table in which the pattern(s) and a corresponding forwarding destination(s) are associated with each other; and
wherein, by referring to the first table, the switch control unit creates control information for instructing forwarding of packets that match the pattern(s) to the corresponding forwarding destination(s) and sets the control information at least in the switch.

12. The control apparatus according to claim 4;
wherein the control apparatus is connected to a control-target-communication notification apparatus that updates the first table.
